(19) United States
(12) Patent Application Publication
(10) Pub. No.: US 2014/0151314 A1
(43) Pub. Date: Jun. 5, 2014

(54) STAND STRUCTURE FOR CUP-SHAPED ARTICLE

(71) Applicant: Fang Yin CHEN, Taichung City (TW)

(72) Inventor: Fang Yin CHEN, Taichung City (TW)

(21) Appl. No.: 13/693,799

(22) Filed: Dec. 4, 2012

(51) Int. Cl. F16M 11/00

(52) U.S. Cl. CPC F16M 11/00
USPC 211/85.18

(57) ABSTRACT

A stand structure is provided for placement of cup-shaped articles. The stand structure includes two upright rods which have a plurality of pairs of spaced and symmetrical protruding portions. A transverse rod is connected between each pair of the protruding portions. An accommodation space is formed between two upper and lower transverse rods to accommodate a cup-shaped article. The edge of a cup cover of the cup-shaped article is against the corresponding transverse rods and the corresponding protruding portions to position the cup-shaped article. The cup-shaped articles can be arranged in order and used conveniently.

### BACKGROUND OF THE INVENTION

1. Field of the Invention

The present invention relates to a stand structure, and more particularly, to a stand structure for cup-shaped articles to be arranged in order and used conveniently.

2. Description of the Prior Art

Coffee mate, coffee cream and coffee are packed in a small-sized cup shape. A conventional way to accommodate cup-shaped articles uses a bag, a box or a case, namely, many cup-shaped articles are placed in a bag or a box. The cup-shaped articles are in a mess and untidy. Sometimes, they may impact each other to be deformed or cracked. When in use, the user always takes out the upper articles in the bag and resupplies the articles of the upper layer. This way results in that the articles of the lower layer are overdue. The bag or box must be opened each time, so it is inconvenient for use.

Accordingly, the present invention intends to provide a stand structure for a cup-shaped article for improving the shortcomings mentioned above.

### SUMMARY OF THE INVENTION

The primary object of the present invention is to provide a stand structure for a cup-shaped article. The stand structure comprises two upright rods. The two upright rods have a plurality of pairs of spaced and symmetrical protruding portions. A transverse rod is connected between each pair of the protruding portions. An accommodation space is formed between two upper and lower transverse rods to accommodate a cup-shaped article. A cup cover of the cup-shaped article is against the corresponding transverse rods and the corresponding protruding portions to position the cup-shaped article, such that many cup-shaped articles can be arranged in order and used conveniently, without be jammed.

### BRIEF DESCRIPTION OF THE DRAWINGS

FIG. 1 is a perspective view of the present invention;

FIG. 2 is a side view of the present invention when in use;

FIG. 3 is a perspective view showing another embodiment of the upright rods of the present invention;

FIG. 4 is a perspective view according to another embodiment of the present invention;

FIG. 5 is a side view of FIG. 4 when in use;

FIG. 6 is a perspective view showing several upright rods arranged in a line; and

FIG. 7 is a perspective view showing several upright rods arranged in a circle.

### DETAILED DESCRIPTION OF THE PREFERRED EMBODIMENTS

Embodiments of the present invention will now be described, by way of example only, with reference to the accompanying drawings.

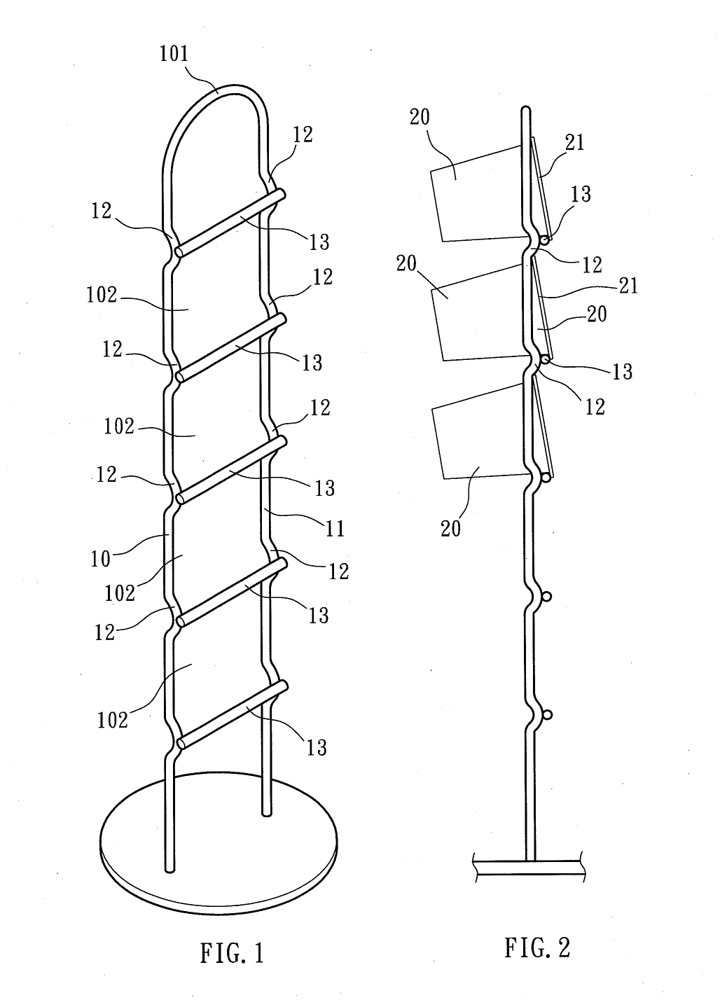

As shown in FIG. 1 and FIG. 2, the present invention comprises two upright rods 10, 11. The two upright rods 10, 11 have a plurality of pairs of spaced and symmetrical protruding portions 12 and a connection section 101 connected between upper ends of the two uprights rods 10, 11. The connection section 101 is convenient for carrying. A transverse rod 13 is connected between each pair of the protruding portions 12. An accommodation space 102 is formed between two upper and lower transverse rods 13 to accommodate a cup-shaped article 20.

According to the foregoing configuration, the present invention has the following effects and advantages. As shown in FIG. 2, the cup-shaped article 20 is placed in the accommodation space 102 formed between two transverse rods 13. The upper edge of a cup cover 21 is against the corresponding protruding portions 12 of the two upright rods 10 11 and the lower edge of the cup cover 21 is against the corresponding transverse rods 13, providing a positioning effect. In this way, many cup-shaped articles 20 can be arranged in order on the stand structure. Therefore, there is no jammed problem and it is convenient for use.

The present invention can be practiced in the following forms.

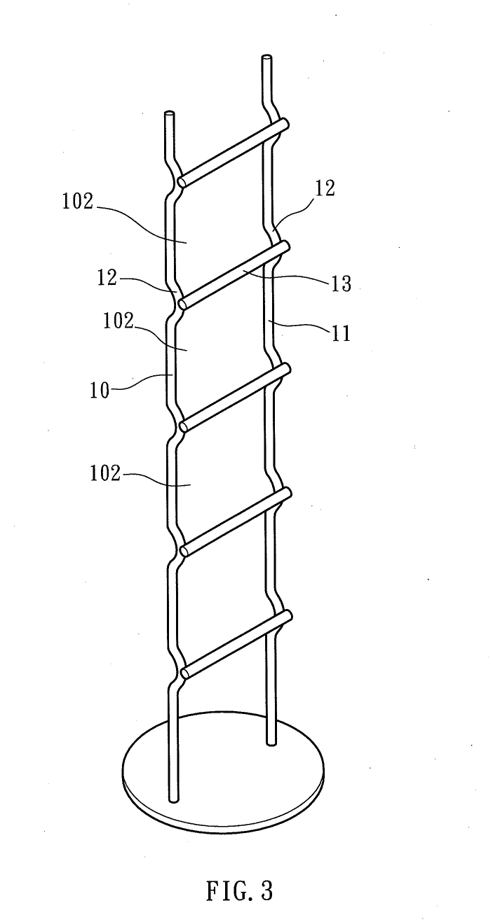

1. As shown in FIG. 3, the upper ends of the two upright rods 10, 11 are open ends, without the connection section. The two upright rods 10, 11 also have the protruding portions 12 and the transverse rods 13 to position the cup-shaped articles.

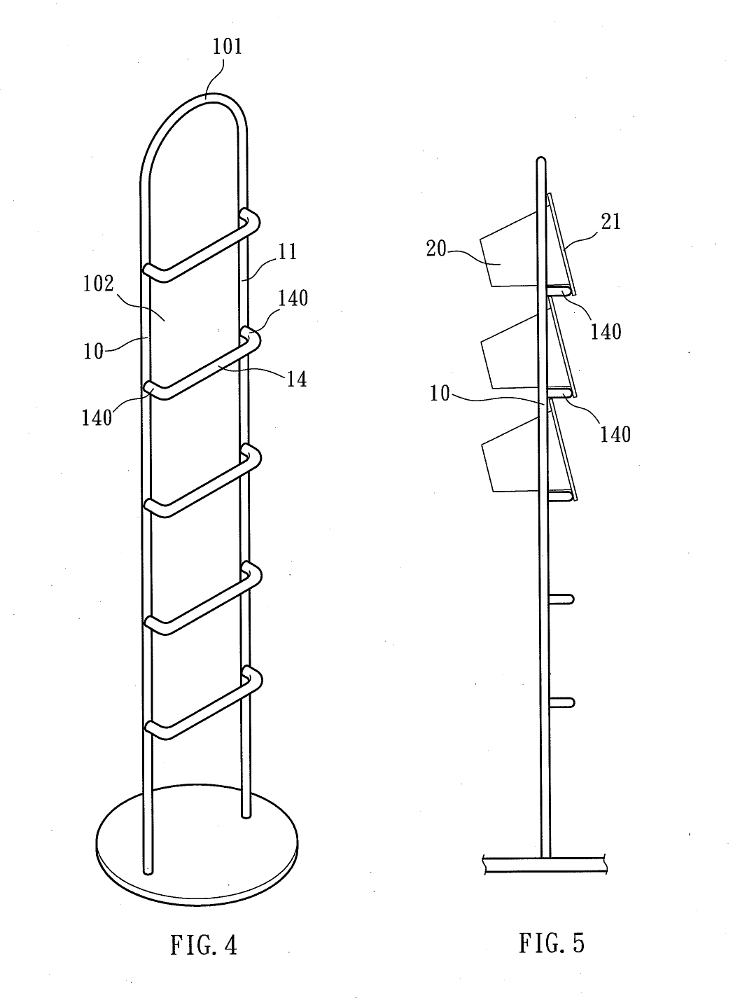

2. As shown in FIG. 4 and FIG. 5, the transverse rod 14 between the two upright rods 10, 11 has protruding bars 140 connected to the two upright rods 10, 11. An accommodation space 102 is formed between two upper and lower transverse rods 14. When the cup-shaped article 20 is placed in the accommodation space 102, the upper edge of the cup cover 21 is against the lower ends of the protruding bars 140 and the lower edge of the cup cover 21 is against the transverse rods 14 to provide a positioning effect.

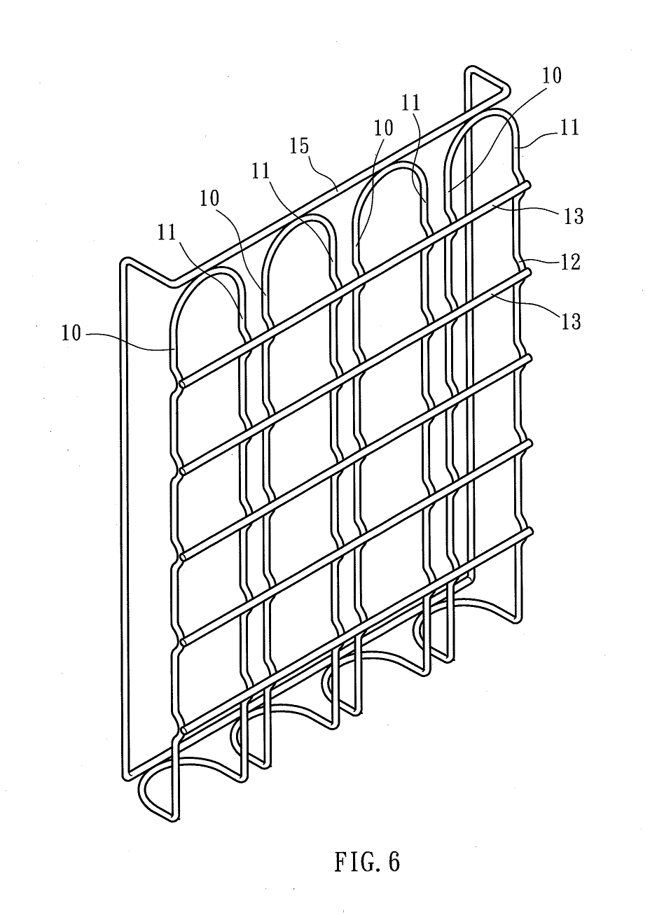

3. As shown in FIG. 6, several upright rods 10, 11 are welded to a linear connection rod 15 for placement of more cup-shaped articles.

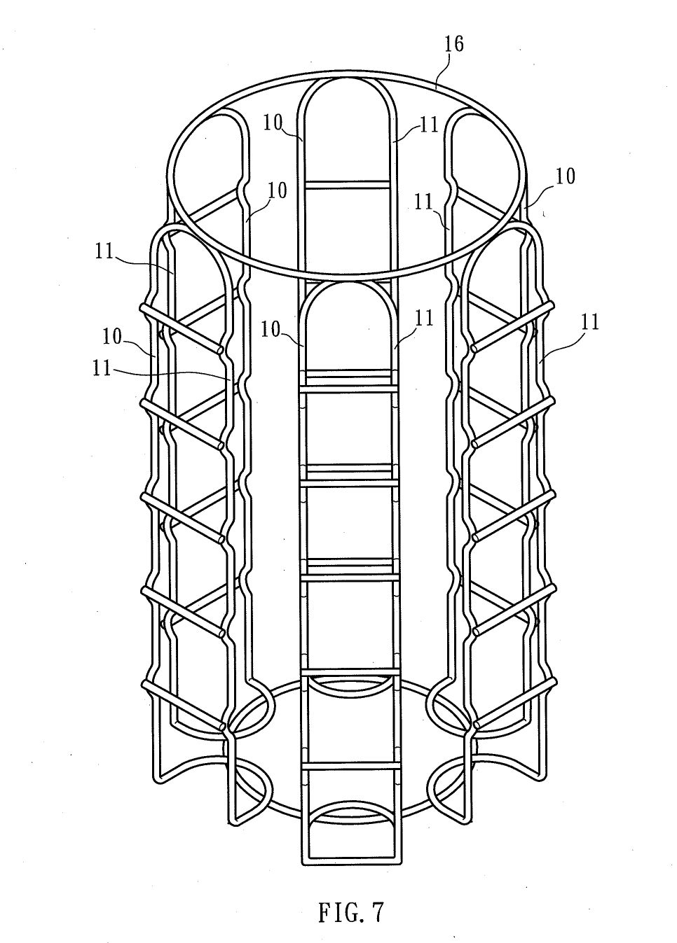

4. As shown in FIG. 7, several upright rods 10, 11 are welded to a circular connection rod 16 for placement of more cup-shaped articles.

Although particular embodiments of the present invention have been described in detail for purposes of illustration, various modifications and enhancements may be made without departing from the spirit and scope of the present invention. Accordingly, the present invention is not to be limited except as by the appended claims.

1-2. (canceled)

3. A stand structure for holding at least a cup-shaped article which comprises a cup cover with an upper edge and a lower edge, wherein the stand structure comprises:
two upright rods being bent to form a plurality of pairs of spaced and symmetrical protruding portions extended in a same direction perpendicular to a plane between said two upright rods; and
upper and lower transverse rods, wherein each of said upper and lower transverse rods is connected between each pair of said protruding portions of said upright rods, wherein an accommodation space is formed between said upper and lower transverse rods for accommodating the cup-shaped article, wherein said protruding portions of said upright rods at said upper transverse rod are arranged for holding the upper edge of the cup cover of the cup-shaped article, wherein said lower transverse rod is arranged for holding the lower edge of the cup cover of the cup-shaped article in order to position the cup-shaped article between said upper and lower transverse rods.

4. The stand structure, as recited in claim 3, further comprising a connection section connected between upper ends of said two upright rods to carry said stand structure.

5. A stand structure for holding at least a cup-shaped article which comprises a cup cover with an upper edge and a lower edge, wherein the stand structure comprises:
two upright rods; and
upper and lower transverse rods for holding the upper edge and the lower edge of the cup cover of the cup-shaped article respectively, wherein said upper and lower transverse rods are connected between said two upright rods at spaced intervals, wherein each of said upper and lower transverse rods has two protruding bars at two ends thereof and connected to said two upright rods respectively, wherein an accommodation space is formed between said upper and lower transverse rods for accommodating the cup-shaped article, wherein said protruding bars of said upper transverse rod are arranged for holding the upper edge of the cup cover of the cup-shaped article, wherein said lower transverse rod is arranged for holding the lower edge of the cup cover of the cup-shaped article in order to position the cup-shaped article between said upper and lower transverse rods.
